(19) United States
(12) Patent Application Publication
(10) Pub. No.: US 2014/0242568 A1
(43) Pub. Date: Aug. 28, 2014

(54) APPARATUS FOR REPRODUCING AND ERASING MAGNETIC VISUAL INFORMATION

(71) Applicant: Franciscus Martinus Gerardus van Creij, Rosmalen (NL)

(72) Inventor: Franciscus Martinus Gerardus van Creij, Rosmalen (NL)

(21) Appl. No.: 14/234,234

(22) PCT Filed: Jul. 20, 2012
(86) PCT No.: PCT/NL2012/000057

§ 371 Date: May 6, 2014

(30) Foreign Application Priority Data
Jul. 22, 2011 (NL) 2007168

(51) Int. Cl. B43L 1/00; G09F 9/37

(52) U.S. Cl. CPC B43L 1/00; G09F 9/37
USPC 434/409

(57) ABSTRACT

The invention relates to an apparatus for temporarily displaying visual information, comprising a frame, a plate of material included in the frame that changes colour due to local pressure and when exposed to a magnetic field, assumes its original colour, a magnet movable along the plate, guide means for guiding the magnet along the sheet in a fast position, wherein the magnet is arranged for erasing a part of the plate by its magnetic field during the movement along the plate, whereby the guide means arc arranged for guiding the magnet along a path in a second position different from the first position, whereby the magnetic field generated by the magnet does not erase the first part of the plate and the device comprises operation means for operating between the first and second position of the magnet.

The present invention relates to a device for at least temporarily displaying visual information, comprising a frame, a frame included in the sheet of material which under local pressure will change to a new colour from its original colour, and that upon exposure to a magnetic field will adopt its original colour, at least a first, connected to the frame, along the plate movable magnet and guide means, connected to the frame to guide the first magnet, wherein the first magnet is arranged to delete the first part of the carrier generated by the magnetic field during the movement along the sheet.

Such devices are known, in particular as a toy. It is the plate of a composite material, that under local pressure changes colour and when exposed to a magnetic field, again assumes its original colour. At to the state of the art devices there is always associated with a magnet movable along the plate, which in its movement along the plate, will erase the entire plate.

Such devices are also suitable for other applications, for example to display rapidly changing information, such as sport matches, in which the position can be tracked. In such applications, it is important that a part of the plate can be erased and on the other part of the plate the present information will be maintained.

In order to meet this demand, the invention provides such an apparatus in which the guide means are arranged for a deviation from the first position to a second position along a path guiding the first magnet and wherein the by the first magnetic-generated magnetic field to the first part of the plate will not be erased and that the apparatus comprises means for operating it from the first position to the second position and from the second position to the first position of the first magnet.

As a result of these measures it is possible to move the magnet in such a way along the plate that in dependence on the position of the magnet, the plate may or may not be erased. Herewith it is possible, for example, starting from a lower position of the magnet, to move the magnet in the non-wiping position to a part of the plate which should be erased, to take the magnet into the wiping position and to further move the erasing magnet to the end of the portion to be deleted. The magnet can then be moved back again to its non-wiping position, and can be brought back to its starting position.

According to a first structurally attractive embodiment the first magnet in the second position will move to a second path, deviated from the first path, and the distance between the second path and the plate is greater than the distance between the first path and the plate. This embodiment uses the fact that the strength of a magnetic field decreases with increasing distance to the magnet. In the first path, the distance between the magnet and the plate is so small that the magnetic field is sufficiently strong to allow the plate to return to its original colour and to ensure that the plate is erased, and the second path, the distance between the magnet and the plate is so large that the magnetic field at the location of the plate is so weak that there is no erasing operation.

It is, however, possible to use other features such as the application of a magnetic screen. The particular embodiment provides the measure that only in the second position of the first magnet between the first magnet and the carrier a magnetic screen is placed. In this case the magnetic screen is capable of operation so that in the absence of the screen between the magnet and the plate the magnetic field emanating from the magnet performs its wiping operation and in the presence of the screen between the plate and the magnet, the magnetic field at the location of the plate, is so weak that no wiping action occurs.

In the above-illustrated embodiment, the magnetic shield can be attached to the frame, but it is also possible that the magnetic screen is mounted to the sledge and the magnet moves with the sledge.

It is also possible that the first magnet in the second position is rotated with respect to its first position about an axis which intersects the connecting line between the magnet poles. To this end, the magnet should be rotatable or tiltable to the slide to be fixed. This embodiment uses the fact that the magnetic field generated by a magnet, is strongly dependent on the direction of the magnet.

In the described embodiments up to now, there is always a part of the plate which it is optional whether or not to be erased, which parts by themselves transversely to the direction of movement of the plate extending lines are separated from the other parts of the plate. In some cases, for example in scoreboards, there is a need to choose whether or not to delete the portions of the plate that are separated by lines extending parallel to the movement direction. To this end a further embodiment, the measure that the device is provided with at least a second magnet, in that the guide means are adapted to it along the sheet guiding the first magnet in which the by the first magnet in its first position generated magnetic field only a first part of knew that the plate and the guide means are arranged for guiding the sheet along the second magnet in which the second magnet by the magnetic field generated in its first position only a second portion of the plate did.

In particular, but not exclusively with scoreboards it is attractive when a number of columns is available, parts of which either may or may not be erased. To this end, a further embodiment provides the measure that the first part of the plate and the second part of the plate are mutually exclusive. This results in adjacent columns which can be erased independently of each other.

Although other configurations, such as centered configurations cannot be excluded, it is preferred that the guide means are arranged to flow linear paths by the magnets and for the erasing of parallel to each other extending strips of the plate in the first position.

According to a constructively attractive embodiment, the guide means comprises at least one to the frame associated guide strip, at least one of the guiding lines comprises part of the sledge, at least one with the slide connected magnet carrier for carrying the magnet, at least a pusher element for the manual pushing of the sledge and an operating element to move the magnet between the first and the second position.

When use is made of the property of a magnetic field which its strength decreases with increasing distance from the magnet, it is structurally attractive that the magnet carrier about an principally parallel to the direction of movement of the sledge tiltable with the sledge is connected, and that the control element is linked to the magnet holder to move the magnet between a first and a second path.

The construction is further simplified when the device contains at least two guide strips, each of which included to the frame, at least one sledge is provided on each of the guide strips, on each sledge a magnet carrier and a pushing element has been placed and when, on each sledge at least one magnet carrier linked by an element carrier has been inserted.

According to a further preferred embodiment, on each guide strip at least two sledges are provided. In the first place, this measure makes it possible to erase more than one strip with one single conductor, wherein the strips can coincide and can differ from each other. In particular, in the case of a coincident strip it may be attractive to approach strip portions from two ends of a strip, because the distance to be maintained between the parts to be deleted is reduced. In case of separate strips a single conductor is sufficient.

Furthermore, it may be attractive to delete only one part of the extending width of a strip. To this end, a further embodiment provides the measure that the trajectories of the slides at least partially overlap each other, and that the strip covered by the second magnet forms a part of the strip covered by the first magnet.

A first field of application of the invention lies in the use as a notice board, but perhaps a more important field of application is the application as a scoreboard, in particular, a scoreboard for dartsport.

The invention will be elucidated with reference to the drawings, in which:

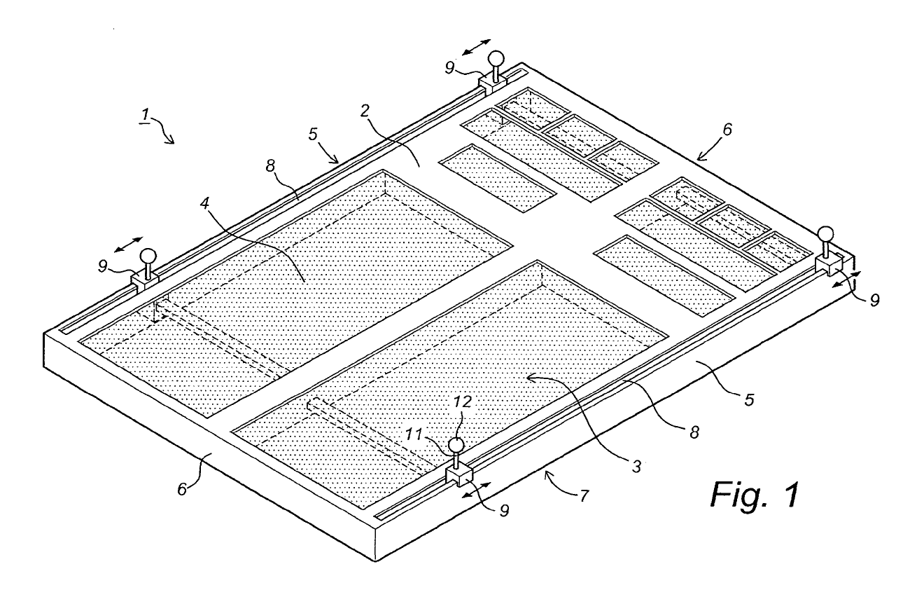

FIG. 1 shows a perspective schematic view of a scoreboard according to the invention;

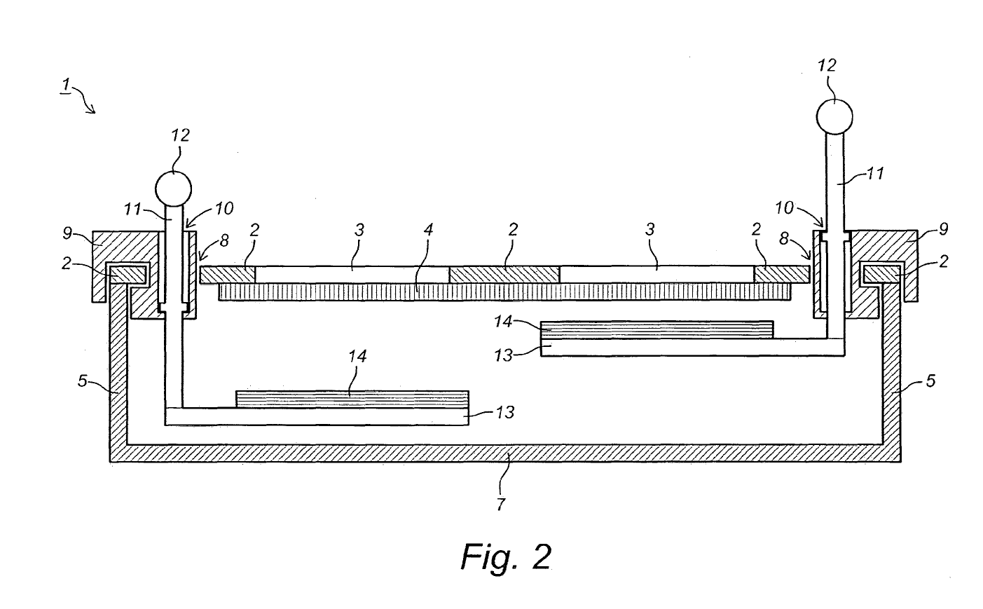

FIG. 2 shows a cross-sectional view of the scoreboard in FIG. 1 depicted, and

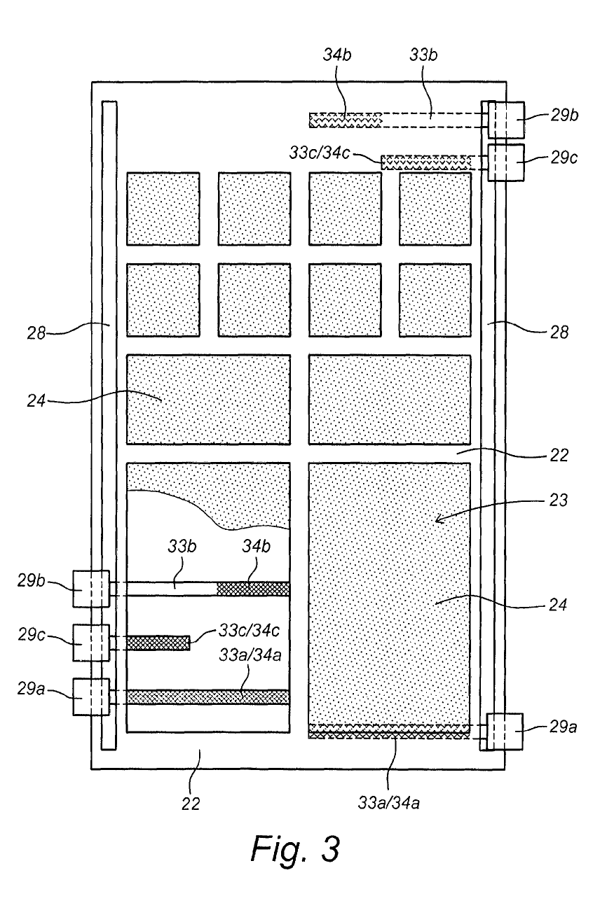

FIG. 3 shows a top view of a variant of the FIGS. 1 and 2 in the embodiment shown.

In FIG. 1, a in its entirety scoreboard is shown indicated by 1. The layout of the scoreboard makes it suitable for indicating the scores of the dartsport, but it will be clear that by choosing a different format the scoreboard can be adapted for other sports. The scoreboard 1 comprises a top plate 2, provided with openings 3. Beneath the top plate is a pressure-sensitive magnetic material made of plate 4 attached. On both sides of the top plate 2 are its side plates 5 attached and to the top and bottom are locking plates 6 attached. At the lower edges of the side plates 5 and locking plates 6 is a bottom plate 7 fixed. Thus, the structure of a flat box is obtained, which by means of suitable suspension means, for example, may be attached against a wall.

With the structure thus obtained the surface of the magnetic plate 4 could be described by means of a pin. Indeed, the pin exerts pressure on the magnetic plate 4 so that in place the pin is pressuring, the colour of the magnetic plate 4 will change.

To delete the visual information thus made on magnetic plate 4, use is made of the wiping course of the device which will be partly discussed on the basis of FIG. 2. FIG. 2 shows in cross-section in the apparatus shown in the top plate 2 comprises two grooves 8, which extends parallel to the side walls 5 extend. In these grooves 8, the respective side edge of the top plate 2 comprise slides 9 are provided, in which further engage able with the respective side wall 5. These slides 9 are therefore movable in the longitudinal direction of the scoreboard 1. In each of the slides 9 is a transversely to the plane of the upper plate 2 extending hole 10 drilled. In each of the holes 10 is a pin 11 is arranged, which at its outer side of a button 12 is provided. The pin is preferably of a non-shown in the drawing provided with wedge, which engages in a slide 9 provided in the corresponding, also non-displayed keyway. By the combination of key and keyway to prevent that pin 11 can rotate with respect to the slide 9. However, the pin 11 can be moved in its axial direction. Furthermore, the effect of the key and keyway may also be obtained by the application of a non-round hole 10 and a non-round pin 11 in appropriate there. On the underside of the pins 11 is a rod 13 which extends parallel to the upper plate 2 extends. On each of the rods 13 is a magnet 14 is positioned, wherein the poles of the magnets 14 located on the top and bottom of the magnet 14 are to ensure that the magnet 14 by the respective magnetic field is transmitted to the upper plate.

In the in FIG. 2 on the right display position of the magnet 14, is the magnet 14 is located at a short distance from the magnetic plate 2 so that during the movement of the slide 9 in the direction transverse to the plane of the drawing, any visual information on the magnetic plate 2 is deleted. This position of the magnet 14 is achieved without the button 12 of the respective slide 9 to touch, in that a spring not shown in the drawing the pin 11 down to the appropriate position.

In the in FIG. 2 shown to the left situation the magnet 14 is at a great distance from the magnet plate 2, so that in the movement of the sledge 9 in the direction transverse to the plane of the drawing, any visual information on the magnetic disc 2 will not be erased. This position of the magnet 14 is achieved by turning the button 12 to press against the spring force of the spring not shown in the drawing.

FIG. 3 shows the top view of a variant of FIGS. 1 and 2 in the embodiment shown. The figure shows the top plate 22, which is provided with openings 23 through which the magnetic plate 24 is visible. To each of the side edges of the top plate 22 is a slot 28 is arranged, in each of which three sledges 29a, 29b and 29c are movable. The construction of each of the sledges 29 is similar to that of the sledges 9 in accordance with the foregoing embodiment. At the first pair of sledges 29A is a long rod 33a provided, which is provided with an extending over the entire length of the rod 33a extending magnet 34a. On the second pair of sledges 29b is a long rod 33b fitted, which is provided with one only extend over the half of the sledge which faces away from the rod 33b extending magnet 34b. On the third pair of sledges 29c, 33c is a short-rod whose length corresponds to half of that of the long rods 33a, 33b, which is provided with an extending over the entire length of the short rod 33c extending magnet 34c. Each of the sledges 29 is movable along the corresponding slot 28 in the longitudinal direction of the upper plate 22. In addition, each sledge 29 is provided with an actuating mechanism is provided for changing the position of the respective magnet 34, in accordance with the foregoing embodiment.

In this embodiment, it is of importance that the by placing it in the active position of one of the magnets 34a to move the sledges 29a of the magnetic plate across the half-width of the scoreboard will be deleted, as in the previous embodiment. The present embodiment, however, offers in addition the possibility of only a part of the half-width to be deleted, namely, with the magnets 34b and the sledge 29b for the part towards the center is situated, and with the magnets 34c and the sledge 29c for the part that is to the edges of the scoreboard is located. This makes it possible for only a part of the score to be deleted, for example, a correction. It is important that the magnets 34b and 34c, only a portion of the path of the magnet cover 34a, so that only a part of the magnetic plate 22 in the present information may be erased.

It will be apparent that numerous modifications may be made to the above-explained embodiments. Thus, it is possible, for example the features of the invention to be applied to a bulletin board as it does in the kitchen is used.

1-15. (canceled)

16. Device for at least temporarily displaying visual information, comprising:
a frame;
a plate included in said frame, the plate of a material that under local pressure locally changes from its original colour to a new colour, and that upon exposure to a magnetic field regains its original colour;
at least a first magnet, connected to said frame, said first magnet movable along said plate;
guiding means connected to said frame, configured to guide said first magnet along a first track in a first position along said plate, in which the first magnet is designed to erase a first part of the plate by means of its generated magnetic field, while moving along the plate, characterized in that
the guiding means are designed to guide the first magnet in a second position, different from the first position, along a track, in which the generated magnetic field generated by the first magnet does not erase the first part of the plate, and wherein the device comprises control means to reposition the first magnet from the first position to the second position and from the second position to the first position.

17. Device according to claim 16, characterized in that in the second position of the first magnet the first magnet moves along a second track, different from the first track, and the distance between the second track and the plate is larger than the distance between the first track and the plate.

18. Device according to claim 16, characterized in that only in the second position of the first magnet a magnetic screen is placed between the first magnet and the plate.

19. Device according to claim 18, characterized in that the magnetic screen is designed to move with the first magnet along its track.

20. Device according to claim 16, characterized in that in said second position, the first magnet is rotated with respect to said first position.

21. Device according to claim 16, characterized in that
the device comprises at least a second magnet;
the guiding means are designed to guide the first magnet along the plate in which the generated magnetic field of the first magnet in its first position only erases a first part of the plate; and
the guiding means are designed to guide the second magnet along the plate in which the generated magnetic field of the second magnet in its first position only erases a second part of the plate.

22. Device according claim 21, characterized in that the first part of the plate and the second part of the plate are mutually exclusive.

23. Device according to claim 21, characterized in that the guiding means are designed to guide the magnets in linear tracks and, in the first position, to erase the plate in parallel to each other extending strips.

24. Device according to claim 16, characterized in that said guiding means comprise:
at least one guiding strip being part of frame;
minimally one carriage at least partly encompassing the guiding strips;
at least one magnet support connected to the carriage to carry the magnet;
at least one push element to move the carriage by hand; and
a control means to reposition the magnet between the first and the second position.

25. Device according claim 24, characterized in that said magnet support is titltably connected with the carriage substantially parallel to a direction of movement, and in that the control means is connected to the magnet support for repositioning the magnet tween a first track and a second track.

26. Device according to claims 24, characterized in that the device at least comprises two guiding strips, each being part of the frame, that each guiding strip is fitted with at least one carriage, that each carriage is applied with a push element, and that each carriage is equipped with at least one magnet support provided with a control means.

27. Device according to claims 24, characterized in that each guiding strip is fitted with at least two carriages.

28. Device according to claim 27, characterized in that the trajectories of said carriages at least party overlap each other, and that a strip covered by the second magnet is part of a strip covered by the first magnet.

29. Device according to one of the claims 16, characterized in that the device involves a bulletin board.

30. Device according to one of the claims 16, characterized in that the device involves a scoreboard, for example a darts scoreboard.

31. Device according to claim 17, characterized in that only in the second position of the first magnet a magnetic screen is placed between the first magnet and the plate.

32. Device according to claim 17, characterized in that in said second position, the first magnet is rotated with respect to said first position.

33. Device according to claim 18, characterized in that in said second position, the first magnet is rotated with respect to said first position.

34. Device according to claim 19, characterized in that
the device comprises at least a second magnet;
the guiding means are designed to guide the first magnet along the plate in which the generated magnetic field of the first magnet in its first position only erases a first part of the plate; and
the guiding means are designed to guide the second magnet along the plate in which the generated magnetic field of the second magnet in its first position only erases a second part of the plate.

35. Device according to claim 22, characterized in that the guiding means are designed to guide the magnets in linear tracks and, in the first position, to erase the plate in parallel to each other extending strips.
